(19) United States
(12) Patent Application Publication
(10) Pub. No.: US 2022/0014381 A1
(43) Pub. Date: Jan. 13, 2022

(54) MESSAGE AUTHENTICATION CODE (MAC) GENERATION FOR LIVE MIGRATION OF ENCRYPTED VIRTUAL MACHINESS

(71) Applicant: Intel Corporation, Santa Clara, CA (US)

(72) Inventor: Bin Xing, Hillsboro, OR (US)

(73) Assignee: Intel Corporation, Santa Clara, CA (US)

(21) Appl. No.: 17/448,520

(22) Filed: Sep. 22, 2021

(51) Int. Cl. H04L 9/32; H04L 9/06; G06F 9/48

(52) U.S. Cl. CPC H04L 9/3242; G06F 9/4856; H04L 9/0656

(57) ABSTRACT

A system and method of MAC generation include receiving, by a destination computing system, an encrypted page from a source computing system; decrypting the encrypted page; adding version data for the decrypted page to a receiver message authentication code (MAC) for the decrypted page; receiving a sender MAC corresponding to the encrypted page received from the source computing system, the sender MAC including version data for the encrypted page; comparing the sender MAC to the receiver MAC; and indicating an error when the sender MAC does not match the receiver MAC and indicating a success when the sender MAC matches the receiver MAC.

### FIELD

Embodiments relate generally to computer security, and more particularly, to generation of MACs for live migration of encrypted virtual machines in computing systems.

### BACKGROUND

A virtual machine (VM) may be encrypted using cryptographic techniques to provide protection to code and data within the VM. One implementation of an encrypted VM (EVM) is the Secure Encrypted Virtualization (SEV) available from Advanced Micro Devices, Inc. Another implementation of an EVM is provided by Trust Domain Extensions (TDX), a security feature of some processors available from Intel Corporation that introduce architectural elements to deploy hardware-isolated virtual machines. Intel® TDX removes the host virtual machine manager (VMM) from the trusted computing bases (TCBs) of VMs and protects the confidentiality and integrity of the processor context, memory, and other metadata (e.g., static/runtime measurement, etc.) of VMs. A VM protected by TDX is usually referred to a trust domain (TD).

Live migrating an EVM (whether provided by SEV or Intel® TDX) involves exporting, transferring (e.g., over a computer network) and importing EVM state from a source computing system to a destination computing system while the EVM is still running on the source computing system. Since the EVM is still running, part of the EVM's state (e.g., memory contents) may change after initial export and must be re-exported to ensure correct results of the live migration. Therefore, freshness (on top of confidentiality and integrity) of the EVM state must be guaranteed for live migration of EVMs.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 is a diagram of a computing arrangement for live migration of an encrypted virtual machine (EVM) according to some embodiments.

FIG. 2 is a flow diagram of MAC sender processing according to some embodiments.

FIG. 3 is a flow diagram of MAC receiver processing according to some embodiments.

FIG. 4 is a schematic diagram of an illustrative electronic computing device to perform MAC processing according to some embodiments.

### DETAILED DESCRIPTION

Implementations of the technology described herein provide a method and system that promotes correctness of an EVM state during live migration. In an embodiment, a message authentication code (MAC) generation process (called a MAC sender herein) accepts an unordered set of messages representing memory pages as input and provides for incremental updates to a MAC when any of the input messages change. Underneath, the MAC generation process relies on non-malleability of an underlying pseudo-random function (PRF) for security.

Embodiments may be employed for authenticating the latest versions of memory pages used by an EVM during live migration of the EVM from a source computing system to a destination computing system. Embodiments handle unordered input messages where the order in which memory pages are exported by the source computing system can be different than the order in which memory pages are imported by the destination computing system. Embodiments also handle a scenario where not all versions of a page are received by the destination computing system. Embodiments handle incremental updates when a once-exported memory page is updated (on the source computing system because the memory page has been changed by the EVM, or on the destination computing system because a more recent version of that same page has been received). In this scenario, the MAC is updated using only the old and new versions of that page. For the version data, this embodiment uses a number assigned by a control entity. But versions could be derived from the page content itself. No information on other pages is necessary to promote the correctness of the live migration. At the end of live migration, verification of correctness of the migration is performed on the destination computing system by comparing the MAC calculated by the destination computing system with the MAC received from the source computing system.

In another embodiments, any data block may be used instead of a memory page, and any transfer of data blocks from source computing system to a destination computing system may be used instead of a live migration scenario.

In an embodiment, an EVM is implemented as a trust domain (TD) that is a hardware isolated virtual machine (VM) deployed using Intel® Trust Domain Extensions (TDX). TDs and Intel® TDX are described in Architecture Specification: Intel® Trust Domain Extensions (Intel® TDX) Module, August 2021, and later versions, and Intel® Trust Domain Architectural Extensions, May 2021, and later versions. In another embodiment, an EVM is implemented as a SEV as described in AMD64 Architecture Programmer's Manual Volume 2: System Programming, Revision 3.37, March 2021, available from AMD, Inc., and later versions.

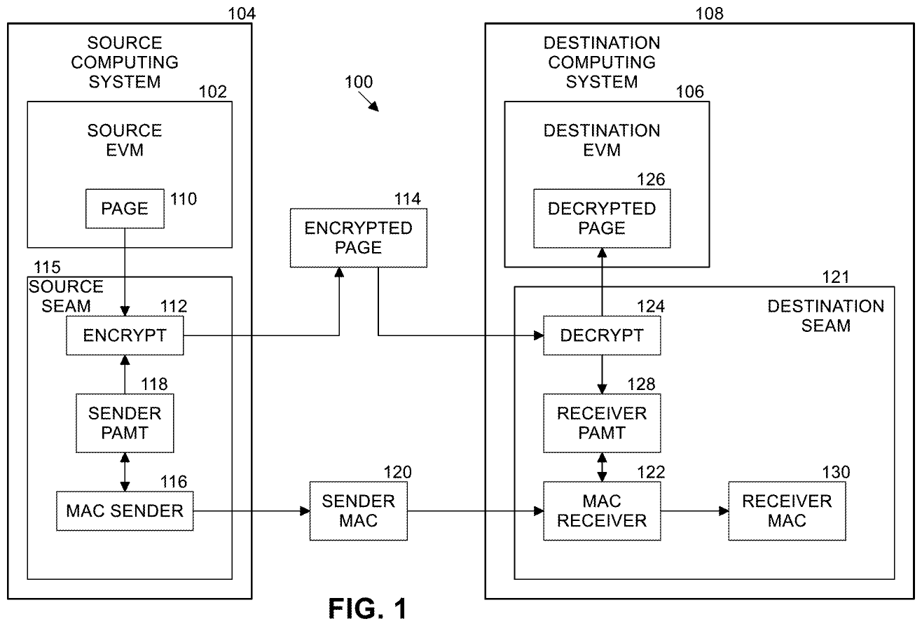

FIG. 1 is a diagram of a computing arrangement 100 for live migration of an EVM according to some embodiments. Source EVM 102 is running on source computing system 104. In some scenarios, source EVM 102 is to be live migrated from source computing system 104 to destination computing system 108. The copy of source EVM 102 becomes destination EVM 106 on destination computing system 108 once live migration is complete. Since source EVM 102 is active on source computing system 104 during the live migration and memory pages accessed by the source EVM may change during the live migration process, embodiments provide a mechanism to promote the correctness of destination EVM 106 when live migration is complete. That is, the final version of destination EVM 106, including memory pages, matches source EVM 102 and it can be asserted that source EVM 102 from source computing system 104 has been correctly live migrated as destination EVM 106 to destination computing system 108.

The mechanism provided by embodiments includes MAC sender 116 running in source secure arbitration module (SEAM) 115 on source computing system 104 and MAC receiver 122 running in destination SEAM 121 running on destination computing system 108. In an embodiment, a SEAM is provided by Intel® processors as described in the Intel® TDX Architecture Specification. As part of the live migration process, source SEAM 115 encrypts page 110 using encrypt function 112 to generate encrypted page 114. Encrypt function 112 may be implemented as software, hardware, or a combination of software and hardware on source computing system 104. Source computing system 104 sends encrypted page 114 to destination computing system 108. Destination SEAM 121 decrypts encrypted page 114 using decrypt function 124. Decrypt function 124 may be implemented as software, hardware, or a combination of software and hardware on destination computing system 108.

MAC sender 116 generates sender MAC 120 based at least in part on page 110 and metadata obtained from sender physical-address-metadata table (PAMT) 118. In an embodiment, metadata include a page version number of a page. Sender MAC 120 is associated with page 110 (and thus encrypted page 114 sent to destination EVM 106). A PAMT is included in an EVM module as a tracking data structure so that a page mapped into a secure extended-page table (SEPT) of an EVM cannot be mapped into SEPT of any other EVM. The PAMT helps ensure that all memory allocated to an EVM is initialized to a known state before first access by the EVM. Source computing system 104 sends sender MAC 120 to destination computing system 108. MAC receiver 122 in destination SEAM 121 receives sender MAC 120. MAC receiver 122 generates a receiver MAC 130 based at least in part on decrypted page 126 and metadata obtained from receiver PAMT 128. In an embodiment, metadata include a page version number of a page. MAC receiver 122 compares sender MAC 120 received from source computing system 104 with receiver MAC 130 generated by the MAC receiver. If the MACs match, the live migration was successful (e.g., correct). If the MACs do not match, the live migration was unsuccessful (e.g., one or more pages are not the latest versions) and an error indication may be raised.

In an embodiment, a MAC T is generated by a same process implemented in MAC sender 116 and MAC receiver 122. The MAC generation process generates T using a pseudorandom function (PRF) whose output bit length is L, L being a natural number. The MAC generation process is defined herein as having an input value M={m₁, m₂, . . . , m_{N}}, M being an unordered set of N version data items, N being a natural number and i in 1 . . . N; an initialization operation where T←0^{L}; an add operation for version data mᵢ (to be authenticated by T) of page Pi where T←T⊗PRF(mᵢ) (with ⊗ being a bitwise XOR operation); a remove operation for mᵢ (from T) where T←T⊗PRF(mᵢ); and an output value T←PRF(T) of bit length L.

Logically, the MAC of each input version data item mᵢ is calculated and then accumulated in T using ⊗ (bitwise XOR), and the final output is the MAC of T. The XOR operation is used here for at least two reasons. Firstly, the XOR operation is commutative, so the order of mᵢ doesn't affect the final output T. Secondly, the XOR operation is invertible, so this allows removing mᵢ from T after mᵢ has been added. The security relies on the non-malleability of the PRF (adversaries cannot alter individual bits of T without knowing the secret key). In an embodiment, a block-cipher based message authentication code (MAC) (e.g., CMAC-AES256) or a hash-based MAC (e.g., HMAC-SHA384) may be used as the PRF. The final application of PRF on T is to prevent adversaries from detecting changes to PRF (mᵢ) from changes to T. In an embodiment, the same MAC is used in the source computing system 104 and the destination computing system 108. In another embodiment, different MACs are used in the source computing system 104 and the destination computing system 108.

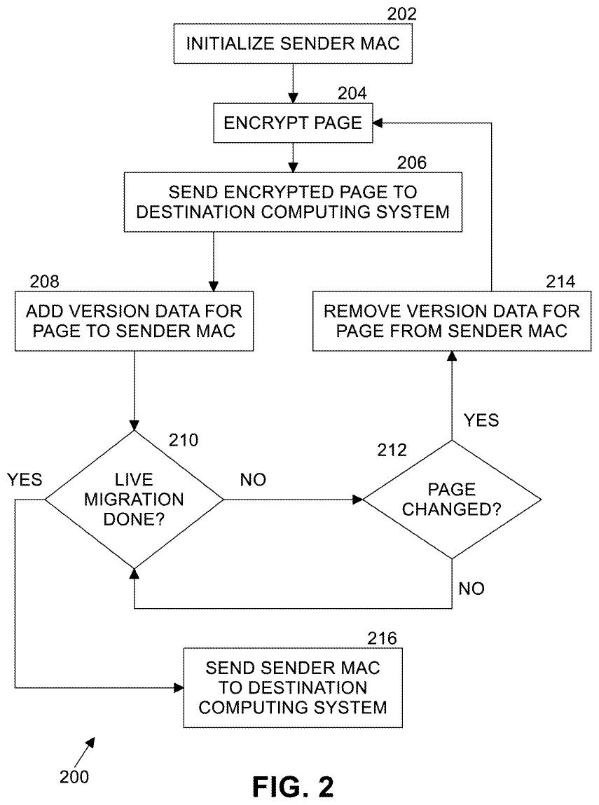

FIG. 2 is a flow diagram of MAC sender 116 processing 200 according to some embodiments. MAC sender 116 generates and sends sender MAC 120 when a page 110 is being exported from source computing system 104 to destination computing system 108 during live migration of source EVM 102. The flow diagram shows how a page Pᵢ is exported in EVM live migration. In an embodiment, mᵢ is defined to be Pᵢ's guest physical address (GPA) (64 bits) concatenated with a translation lookaside buffer (TLB) generation number. In an embodiment, TDX keeps track of a counter, called EPOCH, which indicates the TLB generation. When a page is “blocked” (e.g., made read-only) for encryption, the current TLB generation (called BEPOCH) is captured in PAMT, meaning the page will be read-only for future TLB generation (>BEPOCH). Given BEPOCH's monotonicity, this may be used as a page version.

In an embodiment, the TLB generation number is stored in an entry in sender PAMT 118 corresponding to the page Pᵢ. In an embodiment, the TLB generation number is guaranteed to be incremented when a writable TLB entry is created for the page. Thus, the TLB generation number can serve as a version indicator of the page and is referred to hereafter as a page version number.

A page version number must be bound to the contents of the page, along with other attributes that affect security (e.g., GPA and access permissions (read/write/execute)). However, the binding could be implemented using different approaches. Generally, there are two kinds of bindings. In the first approach, a version is assigned by a control entity. The version is an integer that by itself has no meaning but is bound to the page content/attributes by means of cryptography (e.g., usually a MAC). An Authenticated Encryption with Additional Data (AEAD) cipher may be used for encryption pages because one of its outputs is a MAC that binds the page and its version number together. In the second approach, the version is derived from the page's own content/attributes (e.g., a hash or MAC over its content/attributes). In the second approach, the encrypted pages don't have to be authenticated (AEAD is not required).

At block 202, MAC sender 116 initializes sender MAC 120 to a predefined constant value (e.g., all zeroes). For example, when T has 128 bits, then L=128, and 128 bits of a predefined constant value are stored in T. At block 204, source SEAM 115 encrypts page 110 (Pᵢ) using encrypt function 112. In an embodiment, encrypt function 112 implements an AEAD cipher. For example, the AEAD cipher is Galois Counter Mode Advanced Encryption Standard (GCM-AES), with mᵢ being the initialization vector (IV). At block 206, source computing system 104 sends encrypted page 114 to destination computing system 108. At block 208, MAC sender 116 adds the version data mᵢ for page Pᵢ to sender MAC 120. Note that since the page version number is stored in sender PAMT 118, no additional information need be obtained from a virtual machine monitor (VMM) as part of the live migration of the page.

At block 210, if live migration is done for source EVM 102, then at block 216 MAC sender 116 sends sender MAC 120 to destination computing system 108. If at block 210, live migration is not done, processing continues at block 212. At block 212, if the page has not changed during the live migration process, then processing returns to block 210. At block 212, if the page has changed during the live migration process, then at block 214 MAC sender 116 removes the version data mᵢ for page Pᵢ from MAC tag 120. Processing continues back at block 204, where source EVM 102 requests exporting page pᵢ again (due to the change).

In an embodiment, changes to pᵢ could be observed by a “Dirty” bit being set in a secure extended page table (SEPT), or by an extended page table (EPT) violation VM exit when Pᵢ is blocked (read-only). Once a change is observed, mᵢ can be reconstructed from metadata stored in sender PAMT 118. As above, a VMM is unaware of this processing.

Thus, every time a page is sent from source EVM 102 to destination EVM 106, T is updated with an accumulated value representing all previous page transfers of the live migration. When a page is changed on source EVM 102 that has already been sent to destination EVM 106, T must be adjusted.

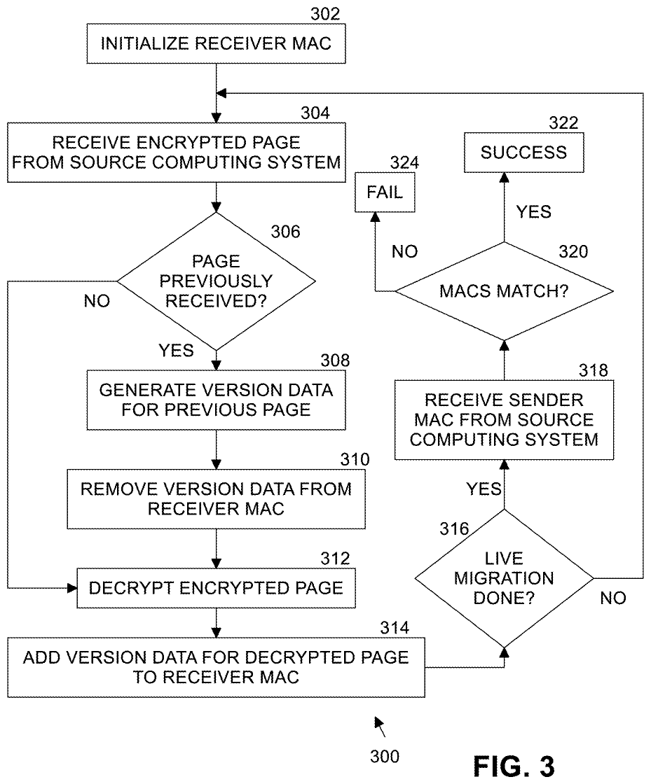

FIG. 3 is a flow diagram of MAC receiver 122 processing 300 according to some embodiments. At block 302, MAC receiver 122 initializes receiver MAC 130 to a predefined constant value (e.g., all zeroes). For example, when T has 128 bits, then L=128, and 128 bits of the predefined constant value are stored in this T. At block 304, destination SEAM 121 receives encrypted page 114 (Pᵢ) from source computing system 104. In an embodiment, MAC receiver 122 also receives metadata for the page such as the GPA and page version number of pᵢ. The page version number may have been previously stored in receiver PAMT 128. At block 306, if this page Pᵢ (in encrypted page 114) has been previously received, then at block 308 MAC receiver 122 generates version data mᵢ for the previous page using the GPA and the page version number. At block 310, MAC receiver 122 removes version data mᵢ from receiver MAC 130. At block 312, decrypt function 124 decrypts the encrypted page 114. In an embodiment, MAC receiver 122 stores the page version number for the page in receiver PAMT 128. If the page has not been previously received at block 306, then processing continues with block 312.

At block 314, MAC receiver 122 adds version data mᵢ for page Pᵢ to receiver MAC 130. At block 316, if live migration is done for source EVM 102, then at block 318, destination computing system 108 receives sender MAC 120 from source computing system 104. MAC receiver 122 compares sender MAC 120 to receiver MAC 130. If the MACs match at block 320, then live migration is a success at block 322. A success indication may be communicated to the source computing system. If the MACs do not match, then live migration has failed at block 324, because at least one of the pages in destination EVM 106 is not the latest version. In this case, an error indication may be raised by MAC receiver 122. If live migration is not done at block 316, processing continues with block 304 and reception of further encrypted pages.

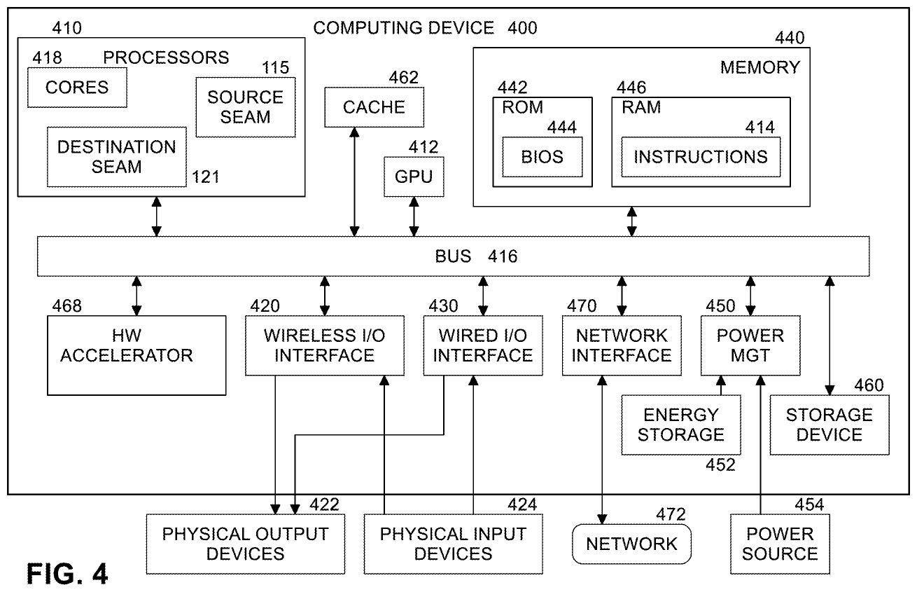

FIG. 4 is a schematic diagram of an illustrative electronic computing device to perform MAC generation processing according to some embodiments. In some embodiments, computing device 400 includes one or more processors 410 including one or more processor cores 418, and either a source SEAM 115, a destination SEAM 1021, or both a source SEAM and a destination SEAM. In some embodiments, the computing device 400 includes one or more hardware accelerators 468.

In some embodiments, the computing device is to implement MAC processing, as provided in FIGS. 1-3 above.

The computing device 400 may additionally include one or more of the following: cache 462, a graphical processing unit (GPU) 412 (which may be the hardware accelerator in some implementations), a wireless input/output (I/O) interface 420, a wired I/O interface 430, system memory 440, power management circuitry 480, non-transitory storage device 460, and a network interface 470 for connection to a network 472. The following discussion provides a brief, general description of the components forming the illustrative computing device 400. Example, non-limiting computing devices 400 may include a desktop computing device, blade server device, workstation, laptop computer, mobile phone, tablet computer, personal digital assistant, or similar device or system.

In embodiments, the processor cores 418 are capable of executing machine-readable instruction sets 414, reading data and/or machine-readable instruction sets 414 from one or more storage devices 460 and writing data to the one or more storage devices 460. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 414 may include instructions to implement MAC generation processing, as provided in FIGS. 1-3.

The processor cores 418 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 400 includes a bus 416 or similar communications link that communicably couples and facilitates the exchange of information and/or data between various system components including the processor cores 418, the cache 462, the graphics processor circuitry 412, one or more wireless I/O interface 720, one or more wired I/O interfaces 430, one or more storage devices 460, and/or one or more network interfaces 470. The computing device 400 may be referred to in the singular herein, but this is not intended to limit the embodiments to a single computing device 400, since in certain embodiments, there may be more than one computing device 400 that incorporates, includes, or contains any number of communicably coupled, collocated, or remote networked circuits or devices.

The processor cores 418 may include any number, type, or combination of currently available or future developed devices capable of executing machine-readable instruction sets.

The processor cores 418 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 4 are of conventional design. Consequently, such blocks need not be described in further detail herein, as they will be understood by those skilled in the relevant art. The bus 416 that interconnects at least some of the components of the computing device 400 may employ any currently available or future developed serial or parallel bus structures or architectures.

The system memory 440 may include read-only memory (“ROM”) 442 and random-access memory (“RAM”) 446. A portion of the ROM 442 may be used to store or otherwise retain a basic input/output system (“BIOS”) 444. The BIOS 444 provides basic functionality to the computing device 400, for example by causing the processor cores 418 to load and/or execute one or more machine-readable instruction sets 414. In embodiments, at least some of the one or more machine-readable instruction sets 414 cause at least a portion of the processor cores 418 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 400 may include at least one wireless input/output (I/O) interface 420. The at least one wireless I/O interface 420 may be communicably coupled to one or more physical output devices 422 (tactile devices, video displays, audio output devices, hardcopy output devices, etc.). The at least one wireless I/O interface 420 may communicably couple to one or more physical input devices 424 (pointing devices, touchscreens, keyboards, tactile devices, etc.). The at least one wireless I/O interface 420 may include any currently available or future developed wireless I/O interface. Example wireless I/O interfaces include, but are not limited to: BLUETOOTH®, near field communication (NFC), and similar.

The computing device 400 may include one or more wired input/output (I/O) interfaces 430. The at least one wired I/O interface 430 may be communicably coupled to one or more physical output devices 422 (tactile devices, video displays, audio output devices, hardcopy output devices, etc.). The at least one wired I/O interface 430 may be communicably coupled to one or more physical input devices 424 (pointing devices, touchscreens, keyboards, tactile devices, etc.). The wired I/O interface 430 may include any currently available or future developed I/O interface. Example wired I/O interfaces include but are not limited to universal serial bus (USB), IEEE 1394 (“FireWire”), and similar.

The computing device 400 may include one or more communicably coupled, non-transitory, storage devices 460. The storage devices 460 may include one or more hard disk drives (HDDs) and/or one or more solid-state storage devices (SSDs). The one or more storage devices 460 may include any current or future developed storage appliances, network storage devices, and/or systems. Non-limiting examples of such storage devices 460 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more storage devices 460 may include one or more removable storage devices, such as one or more flash drives, flash memories, flash storage units, or similar appliances or devices capable of communicable coupling to and decoupling from the computing device 400.

The one or more storage devices 460 may include interfaces or controllers (not shown) communicatively coupling the respective storage device or system to the bus 416. The one or more storage devices 460 may store, retain, or otherwise contain machine-readable instruction sets, data structures, program modules, data stores, databases, logical structures, and/or other data useful to the processor cores 418 and/or graphics processor circuitry 412 and/or one or more applications executed on or by the processor cores 418 and/or graphics processor circuitry 412. In some instances, one or more data storage devices 460 may be communicably coupled to the processor cores 418, for example via the bus 416 or via one or more wired communications interfaces 430 (e.g., Universal Serial Bus or USB); one or more wireless communications interface 420 (e.g., Bluetooth®, Near Field Communication or NFC); and/or one or more network interfaces 470 (IEEE 802.3 or Ethernet, IEEE 802.11, or Wi-Fi®, etc.).

Machine-readable instruction sets 414 and other programs, applications, logic sets, and/or modules may be stored in whole or in part in the system memory 440. Such machine-readable instruction sets 414 may be transferred, in whole or in part, from the one or more storage devices 460. The machine-readable instruction sets 414 may be loaded, stored, or otherwise retained in system memory 440, in whole or in part, during execution by the processor cores 418 and/or graphics processor circuitry 412.

The computing device 400 may include power management circuitry 480 that controls one or more operational aspects of the energy storage device 482. In embodiments, the energy storage device 482 may include one or more primary (i.e., non-rechargeable) or secondary (i.e., rechargeable) batteries or similar energy storage devices. In embodiments, the energy storage device 482 may include one or more supercapacitors or ultracapacitors. In embodiments, the power management circuitry 480 may alter, adjust, or control the flow of energy from an external power source 484 to the energy storage device 482 and/or to the computing device 400. The external power source 484 may include, but is not limited to, a solar power system, a commercial electric grid, a portable generator, an external energy storage device, or any combination thereof.

For convenience, the processor cores 418, the graphics processor circuitry 412, the wireless I/O interface 420, the wired I/O interface 430, the storage device 460, and the network interface 470 are illustrated as communicatively coupled to each other via the bus 416, thereby providing connectivity between the above-described components. In alternative embodiments, the above-described components may be communicatively coupled in a different manner than illustrated in FIG. 4. For example, one or more of the above-described components may be directly coupled to other components, or may be coupled to each other, via one or more intermediary components (not shown). In another example, one or more of the above-described components may be integrated into the processor cores 418 and/or the graphics processor circuitry 412. In some embodiments, all or a portion of the bus 416 may be omitted and the components are coupled directly to each other using suitable wired or wireless connections.

Flow charts representative of example hardware logic, machine readable instructions, hardware implemented state machines, and/or any combination thereof for implementing computing device 400, for example, are shown in FIGS. 2-3. The machine-readable instructions may be one or more executable programs or portion(s) of an executable program for execution by a computer processor such as the processor shown in the example computing device 400 discussed above in connection with FIG. 4. The program may be embodied in software stored on a non-transitory computer readable storage medium such as a CD-ROM, a floppy disk, a hard drive, a DVD, a Blu-ray disk, or a memory associated with the processor 410, but the entire program and/or parts thereof could alternatively be executed by a device other than the processor 410 and/or embodied in firmware or dedicated hardware. Further, although the example program is described with reference to the flowcharts illustrated in FIGS. 2-3, many other methods of implementing the example computing device 400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 2-3 may be implemented using executable instructions (e.g., computer and/or machine-readable instructions) stored on a non-transitory computer and/or machine-readable medium such as a hard disk drive, a solid-state storage device (SSD), a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is method including receiving, by a destination computing system, an encrypted page from a source computing system during a live migration of a source encrypted virtual machine on the source computing system to a destination encrypted virtual machine on a destination computing system; decrypting the encrypted page; adding version data for the decrypted page to a receiver message authentication code (MAC) for the decrypted page; repeating the receiving the encrypted page, decrypting the encrypted page, and adding the version data for the decrypted page, for all encrypted pages received from the source computing system during the live migration; receiving a sender MAC corresponding to the encrypted pages received from the source computing system, the sender MAC including version data for the encrypted pages; comparing the sender MAC to the receiver MAC; and indicating an error in the live migration of the encrypted pages from the source encrypted virtual machine to the destination encrypted virtual machine when the sender MAC does not match the receiver MAC and indicating a success in the live migration of the encrypted pages when the sender MAC matches the receiver MAC.

In Example 2, the subject matter of Example 1 can optionally include wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted pages, and an add operation for version data mᵢ wherein i in 1 . . . N, for page Pi where the sender MAC is accumulated as the sender MAC bitwise XOR PRF (mᵢ) and the receiver MAC is accumulated as the receiver MAC bitwise XOR PRF (mᵢ).

In Example 3, the subject matter of Example 1 can optionally include wherein the version data for the decrypted page comprises a guest physical address (GPA) of the decrypted page concatenated with a page version number of the decrypted page.

In Example 4, the subject matter of Example 3 can optionally include storing the page version number in a physical address metadata table in a secure arbitration module in the destination computing system.

In Example 5, the subject matter of Example 1 can optionally include if the encrypted page has been previously received, generating version data for the previously received encrypted page and removing the version data for the previously received encrypted page from the receiver MAC before decrypting the encrypted page.

In Example 6, the subject matter of Example 1 can optionally include wherein the source computing system includes trust domain extensions and the source encrypted virtual machine comprises a source trust domain, and the destination computing system includes trust domain extensions and the destination encrypted virtual machine comprises a destination trust domain.

In Example 7, the subject matter of Example 1 can optionally include wherein the sender MAC represents an accumulated value for latest versions of all previous encrypted pages received during the live migration.

In Example 8, the subject matter of Example 1 can optionally include wherein the source encrypted virtual machine comprises an encrypted source SEV, and the destination encrypted virtual machine comprises an encrypted destination SEV.

Example 9 is at least one non-transitory machine-readable storage medium comprising instructions that, when executed, cause at least one processing device to at least: receive, by a destination computing system, an encrypted page from a source computing system during a live migration of a source encrypted virtual machine on the source computing system to a destination encrypted virtual machine on a destination computing system; decrypt the encrypted page; add version data for the decrypted page to a receiver message authentication code (MAC) for the decrypted page; repeat the receiving the encrypted page, decrypting the encrypted page, and adding the version data for the decrypted page, for all encrypted pages received from the source computing system during the live migration; receive a sender MAC corresponding to the encrypted pages received from the source computing system, the sender MAC including version data for the encrypted pages; compare the sender MAC to the receiver MAC; and indicate an error in the live migration of the encrypted pages from the source encrypted virtual machine to the destination encrypted virtual machine when the sender MAC does not match the receiver MAC and indicating a success in the live migration of the encrypted pages when the sender MAC matches the receiver MAC.

In Example 10, the subject matter of Example 9 can optionally include wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted pages, and an add operation for version data mᵢ wherein i in 1 . . . N, for page Pi where the sender MAC is accumulated as the sender MAC bitwise XOR PRF (mᵢ) and the receiver MAC is accumulated as the receiver MAC bitwise XOR PRF (mᵢ).

In Example 11, the subject matter of Example 9 can optionally include wherein the version data for the decrypted page comprises a guest physical address (GPA) of the decrypted page concatenated with a page version number of the decrypted page.

In Example 12, the subject matter of Example 9 can optionally include if the encrypted page has been previously received, generate version data for the previously received encrypted page and remove the version data for the previously received encrypted page from the receiver MAC before decrypting the encrypted page.

In Example 13, the subject matter of Example 9 can optionally include wherein the sender MAC represents an accumulated value for latest versions of all previous encrypted pages received during the live migration.

Example 14 is an apparatus comprising a processor; and a memory coupled to the processor, the memory having instructions stored thereon that, in response to execution by the processor, cause the processor to: receive, by a destination computing system, an encrypted page from a source computing system during a live migration of a source encrypted virtual machine on the source computing system to a destination encrypted virtual machine on a destination computing system; decrypt the encrypted page; add version data for the decrypted page to a receiver message authentication code (MAC) for the decrypted page; repeat the receiving the encrypted page, decrypting the encrypted page, and adding the version data for the decrypted page, for all encrypted pages received from the source computing system during the live migration; receive a sender MAC corresponding to the encrypted pages received from the source computing system, the sender MAC including version data for the encrypted pages; compare the sender MAC to the receiver MAC; and indicate an error in the live migration of the encrypted pages from the source encrypted virtual machine to the destination encrypted virtual machine when the sender MAC does not match the receiver MAC and indicating a success in the live migration of the encrypted pages when the sender MAC matches the receiver MAC.

In Example 15, the subject matter of Example 14 can optionally include wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted pages, and an add operation for version data mᵢ wherein i in 1 . . . N, for page Pi where the sender MAC is accumulated as the sender MAC bitwise XOR PRF (mᵢ) and the receiver MAC is accumulated as the receiver MAC bitwise XOR PRF (mᵢ).

In Example 16, the subject matter of Example 14 can optionally include wherein the version data for the decrypted page comprises a guest physical address (GPA) of the decrypted page concatenated with a page version number of the decrypted page.

In Example 17, the subject matter of Example 14 can optionally include instructions, when executed to: if the encrypted page has been previously received, generate version data for the previously received encrypted page and remove the version data for the previously received encrypted page from the receiver MAC before decrypting the encrypted page.

In Example 18, the subject matter of Example 14 can optionally include wherein the sender MAC represents an accumulated value for latest versions of all previous encrypted pages received during the live migration.

Example 19 is a method comprising receiving, by a destination computing system, an encrypted data block from a source computing system; decrypting the encrypted data block; adding version data for the decrypted data block to a receiver message authentication code (MAC) for the decrypted data block; repeating the receiving the encrypted data block, decrypting the encrypted data block, and adding the version data for the decrypted data block, for all encrypted data blocks received from the source computing system; receiving a sender MAC corresponding to the encrypted data blocks received from the source computing system, the sender MAC including version data for the encrypted data blocks; comparing the sender MAC to the receiver MAC; and indicating an error in the encrypted data blocks when the sender MAC does not match the receiver MAC and indicating a success when the sender MAC matches the receiver MAC; wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted data blocks, and an add operation for version data mᵢ wherein i in 1 . . . N, for data block Pi where the sender MAC is accumulated as the sender MAC bitwise XOR PRF (mᵢ) and the receiver MAC is accumulated as the receiver MAC bitwise XOR PRF (mᵢ).

In Example 20, the subject matter of Example 19 can optionally include wherein the version data for the decrypted data block comprises a guest physical address (GPA) of the decrypted data block concatenated with a version number of the decrypted data block.

In Example 21, the subject matter of Example 19 can optionally include if the encrypted data block has been previously received, generating version data for the previously received encrypted data block and removing the version data for the previously received encrypted data block from the receiver MAC before decrypting the encrypted data block.

In Example 22, the subject matter of Example 19 can optionally include wherein the sender MAC represents an accumulated value for latest versions of all previous encrypted data blocks.

Example 23 is an apparatus comprising means for receiving, by a destination computing system, an encrypted page from a source computing system during a live migration of a source encrypted virtual machine on the source computing system to a destination encrypted virtual machine on a destination computing system; means for decrypting the encrypted page; means for adding version data for the decrypted page to a receiver message authentication code (MAC) for the decrypted page; means for repeating the receiving the encrypted page, means for decrypting the encrypted page, and means for adding the version data for the decrypted page, for all encrypted pages received from the source computing system during the live migration; means for receiving a sender MAC corresponding to the encrypted pages received from the source computing system, the sender MAC including version data for the encrypted pages; means for comparing the sender MAC to the receiver MAC; and means for indicating an error in the live migration of the encrypted pages from the source encrypted virtual machine to the destination encrypted virtual machine when the sender MAC does not match the receiver MAC and means for indicating a success in the live migration of the encrypted pages when the sender MAC matches the receiver MAC.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A method comprising:
receiving, by a destination computing system, an encrypted page from a source computing system during a live migration of a source encrypted virtual machine on the source computing system to a destination encrypted virtual machine on a destination computing system;
decrypting the encrypted page;
adding version data for the decrypted page to a receiver message authentication code (MAC) for the decrypted page;
repeating the receiving the encrypted page, decrypting the encrypted page, and adding the version data for the decrypted page, for all encrypted pages received from the source computing system during the live migration;
receiving a sender MAC corresponding to the encrypted pages received from the source computing system, the sender MAC including version data for the encrypted pages;
comparing the sender MAC to the receiver MAC; and
indicating an error in the live migration of the encrypted pages from the source encrypted virtual machine to the destination encrypted virtual machine when the sender MAC does not match the receiver MAC and indicating a success in the live migration of the encrypted pages when the sender MAC matches the receiver MAC.

2. The method of claim 1, wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted pages, and an add operation for version data mᵢ wherein i in 1 . . . N, for page Pi where the sender MAC is accumulated as the sender MAC bitwise XOR PRF (mᵢ) and the receiver MAC is accumulated as the receiver MAC bitwise XOR PRF (mᵢ).

3. The method of claim 1, wherein the version data for the decrypted page comprises a guest physical address (GPA) of the decrypted page concatenated with a page version number of the decrypted page.

4. The method of claim 3, comprising storing the page version number in a physical address metadata table in a secure arbitration module in the destination computing system.

5. The method of claim 1, comprising:
if the encrypted page has been previously received, generating version data for the previously received encrypted page and removing the version data for the previously received encrypted page from the receiver MAC before decrypting the encrypted page.

6. The method of claim 1, wherein the source computing system includes trust domain extensions and the source encrypted virtual machine comprises a source trust domain, and the destination computing system includes trust domain extensions and the destination encrypted virtual machine comprises a destination trust domain.

7. The method of claim 1, wherein the sender MAC represents an accumulated value for latest versions of all previous encrypted pages received during the live migration.

8. The method of claim 1, wherein the source encrypted virtual machine comprises an encrypted source SEV, and the destination encrypted virtual machine comprises an encrypted destination SEV.

9. At least one non-transitory machine-readable storage medium comprising instructions that, when executed, cause at least one processing device to at least:
receive, by a destination computing system, an encrypted page from a source computing system during a live migration of a source encrypted virtual machine on the source computing system to a destination encrypted virtual machine on a destination computing system;
decrypt the encrypted page;
add version data for the decrypted page to a receiver message authentication code (MAC) for the decrypted page;
repeat the receiving the encrypted page, decrypting the encrypted page, and adding the version data for the decrypted page, for all encrypted pages received from the source computing system during the live migration;
receive a sender MAC corresponding to the encrypted pages received from the source computing system, the sender MAC including version data for the encrypted pages;
compare the sender MAC to the receiver MAC; and
indicate an error in the live migration of the encrypted pages from the source encrypted virtual machine to the destination encrypted virtual machine when the sender MAC does not match the receiver MAC and indicating a success in the live migration of the encrypted pages when the sender MAC matches the receiver MAC.

10. The at least one non-transitory machine-readable storage medium of claim 9, wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted pages, and an add operation for version data mᵢ wherein i in 1 . . . N, for page Pi where the sender MAC is accumulated as the sender MAC bitwise XOR PRF (mᵢ) and the receiver MAC is accumulated as the receiver MAC bitwise XOR PRF (mᵢ).

11. The at least one non-transitory machine-readable storage medium of claim 9, wherein the version data for the decrypted page comprises a guest physical address (GPA) of the decrypted page concatenated with a page version number of the decrypted page.

12. The at least one non-transitory machine-readable storage medium of claim 9, comprising instructions, when executed to:
if the encrypted page has been previously received, generate version data for the previously received encrypted page and remove the version data for the previously received encrypted page from the receiver MAC before decrypting the encrypted page.

13. The at least one non-transitory machine-readable storage medium of claim 9, wherein the sender MAC represents an accumulated value for latest versions of all previous encrypted pages received during the live migration.

14. An apparatus comprising:
a processor; and
a memory coupled to the processor, the memory having instructions stored thereon that, in response to execution by the processor, cause the processor to:
receive, by a destination computing system, an encrypted page from a source computing system during a live migration of a source encrypted virtual machine on the source computing system to a destination encrypted virtual machine on a destination computing system;
decrypt the encrypted page;
add version data for the decrypted page to a receiver message authentication code (MAC) for the decrypted page;
repeat the receiving the encrypted page, decrypting the encrypted page, and adding the version data for the decrypted page, for all encrypted pages received from the source computing system during the live migration;
receive a sender MAC corresponding to the encrypted pages received from the source computing system, the sender MAC including version data for the encrypted pages;
compare the sender MAC to the receiver MAC; and
indicate an error in the live migration of the encrypted pages from the source encrypted virtual machine to the destination encrypted virtual machine when the sender MAC does not match the receiver MAC and indicating a success in the live migration of the encrypted pages when the sender MAC matches the receiver MAC.

15. The apparatus of claim 14, wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted pages, and an add operation for version data mᵢ wherein i in 1 . . . N, for page Pi where the sender MAC is accumulated as the sender MAC bitwise XOR PRF (mᵢ) and the receiver MAC is accumulated as the receiver MAC bitwise XOR PRF (mᵢ).

16. The apparatus of claim 14, wherein the version data for the decrypted page comprises a guest physical address (GPA) of the decrypted page concatenated with a page version number of the decrypted page.

17. The apparatus of claim 14, comprising instructions, when executed to:
if the encrypted page has been previously received, generate version data for the previously received encrypted page and remove the version data for the previously received encrypted page from the receiver MAC before decrypting the encrypted page.

18. The apparatus of claim 14, wherein the sender MAC represents an accumulated value for latest versions of all previous encrypted pages received during the live migration.

19. A method comprising:
receiving, by a destination computing system, an encrypted data block from a source computing system;
decrypting the encrypted data block;
adding version data for the decrypted data block to a receiver message authentication code (MAC) for the decrypted data block;
repeating the receiving the encrypted data block, decrypting the encrypted data block, and adding the version data for the decrypted data block, for all encrypted data blocks received from the source computing system;
receiving a sender MAC corresponding to the encrypted data blocks received from the source computing system, the sender MAC including version data for the encrypted data blocks;
comparing the sender MAC to the receiver MAC; and
indicating an error in the encrypted data blocks when the sender MAC does not match the receiver MAC and indicating a success when the sender MAC matches the receiver MAC;
wherein each of the sender MAC and the receiver MAC is generated by a process including a pseudorandom function (PRF) having an input value M={m₁, m₂, . . . , m_{N}}, M being an unordered set of N version data, N being a natural number representing a number of encrypted data blocks, and an add operation for version data mᵢ wherein i in 1 . . . N, for data block Pi where the sender MAC is accumulated as the sender MAC bitwise XOR PRF (mᵢ) and the receiver MAC is accumulated as the receiver MAC bitwise XOR PRF (mᵢ).

20. The method of claim 19, wherein the version data for the decrypted data block comprises a guest physical address (GPA) of the decrypted data block concatenated with a version number of the decrypted data block.

21. The method of claim 19, comprising:
if the encrypted data block has been previously received, generating version data for the previously received encrypted data block and removing the version data for the previously received encrypted data block from the receiver MAC before decrypting the encrypted data block.

22. The method of claim 19, wherein the sender MAC represents an accumulated value for latest versions of all previous encrypted data blocks.
